(19) United States
(12) Patent Application Publication
(10) Pub. No.: US 2014/0129323 A1
(43) Pub. Date: May 8, 2014

(54) PREDICTIVE MODEL FOR ADJUSTING CLICK PRICING

(71) Applicant: MICROSOFT CORPORATION, Redmond, WA (US)

(72) Inventors: Rouben Amirbekian, Pleasanton, CA (US); Ye Chen, Sunnyvale, CA (US); Alan Lu, Santa Clara, CA (US); Tak Yan, Palo Alto, CA (US); Liangzhong Yin, Palo Alto, CA (US)

(73) Assignee: MICROSOFT CORPORATION, Redmond, WA (US)

(21) Appl. No.: 13/670,348

(22) Filed: Nov. 6, 2012

(51) Int. Cl. G06Q 30/02

(52) U.S. Cl. 705/14.45

(57) ABSTRACT

Traffic quality on online properties may be assessed continually, and the traffic quality may be used to determine the price of a click-through for an ad placed on the web property. Advertisers bid on keywords, and the bids are used by an advertising engine to place ads on web pages and other online properties. A benchmark price may be set based on the bids. When a user clicks on (or otherwise activates) an ad, the advertiser pays an amount for the click that is based on the benchmark price and on the traffic quality of the property on which the ad had been placed. Machine learning may be used to create a model that predicts traffic quality based on observable feature of a property, thereby allowing the traffic quality of a property to be assessed in real time rather than historically.

### BACKGROUND

Third party web properties (e.g., web pages, web services accessed through apps, etc.) often invite the placement of ads on their pages, as a way of monetizing the properties. For example, a web page may include code that dynamically obtains ads to be displayed on the page. Similarly, a smart phone or tablet app may include an ad control that obtains ads to be displayed while the app is being used. Normally, a click on the ad results in a charge to the advertiser, and a payment to the owner of the property on which the ad was placed.

The price that advertisers pay for a click is often based on the perceived quality of the traffic at the property on which the ad is placed. The reason to consider traffic quality is that advertisers pay for clicks, but are more likely to care about “conversions,” where a “conversion” is some behavior that the advertiser wants the user to engage in—e.g., making a purchase, filling out a survey, etc. (In some cases, click-like events may be conversions—e.g., in click-to-call or click-to-map scenarios on a mobile device, the call or the retrieval of a map may be both the click and the conversion behavior that the advertiser is seeking.) Some types of web sites or apps have “high quality traffic,” in the sense that people who use the web sites or apps tend to be the type of customers who have high conversion rates, or whose behavior has a high value per conversion event.

Traffic quality is often measured historically. Therefore, the traffic quality measurement may become out of date, which results in the advertiser having to pay more for a click than is justified by the web site's current traffic quality. Some publishers of web properties may even abuse the disparity between historical and current traffic quality—and the time lag in measuring traffic quality historically—in order to inflate their advertising revenue.

### SUMMARY

An online property's traffic quality may be measured, and continually adjusted, in order to minimize the disparity between measured traffic quality and actual traffic quality. The continually-adjusted quality metric may be used as part of a formula that determines how much an advertiser pays per click when ads are placed on the online property. In one example, properties whose traffic quality is inconsistent may have their quality metrics reduced beyond their true value, as a penalty. This penalty may reflect a justified assumption that large swings in the traffic quality of a web site may be the result of the publisher's attempt to manipulate traffic quality ratings to increase advertising revenue.

When ads are placed on an online property, such as a web site or smart phone app, the advertiser generally pays for a click on an ad. However, not all clicks generate the conversion that the advertiser is seeking from the click—e.g., purchase of a retail product, completion of a survey, etc. Traffic that has a higher conversion rate and/or a higher value per conversion is “high quality” traffic from the perspective of the advertiser. Thus, the price that the advertiser pays for a click may be based on the price that the advertiser bid for the keyword that generated the ad, and also on the traffic quality metric for the site. By continually adjusting the quality metric associated with the site, the advertiser pays for a click based on the quality of the traffic at the time the click was generated, rather than based on a historical value that may be out of date.

Calculation of the quality metric may be based on a model that is generated through a machine learning process. The model uses variables that can be measured in real-time to predict the current traffic quality.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example property on which ads may be placed.

FIG. 2 is a block diagram of an example process in which ads are displayed and priced.

FIG. 3 is a flow diagram of an example process that may be used to set a traffic quality factor for a property.

FIG. 4 is a block diagram of a timeline that demonstrate the process of model training and validation.

FIG. 5 is a block diagram of an example system in which traffic quality may be analyzed and use for click pricing.

FIG. 6 is a block diagram of example components that may be used in connection with implementations of the subject matter described herein.

### DETAILED DESCRIPTION

Publishers of web properties (e.g., web pages, or smart phone or tablet apps through which services are accessed) often monetize their properties by allowing ads to be placed on those properties. To place ads, a publisher normally places some type of code on the property that retrieves an ad from an advertising engine. The ad that is placed on the property by the advertising engine may be chosen using a variety of techniques, but is often chosen based on the keywords that appear on the property. In one example, the advertiser bids an amount of money that the advertiser is willing to pay for a click when an impression of the ad is displayed in response to the keyword.

When an advertiser bids on a keyword, the benchmark price that the advertiser pays for a click may be determined by various methods, such as an auction. The benchmark price is a reference price for a click-through (or for some other behavior that triggers payment), that is set without regard to the property on which the ad impression will be placed. However, the actual price that the advertiser pays for a click is often not the benchmark price, but rather some adjustment to the benchmark price based on factors such as the traffic quality of the property on which the advertisement is placed. For example, one web site might have a quality rating of 1.0, and another site might have a quality rating of 0.5. All other factors being equal, the advertiser would pay the benchmark price for a click when the ad is placed on the site with the 1.0 rating, but would pay half the benchmark price for a click when the ad is placed on the site with the 0.5 rating. The site on which the ad is placed receives a portion of the per-click price that the advertiser pays (less the commission received by the advertising engine that places the ad).

Because the price that a publisher receives is based on the perceived quality of a property's traffic, owners of online properties have an incentive to increase the perception of the quality of their traffic. One issue that arises is that there is only so much high quality traffic, and the kind of people who constitute high quality traffic (e.g., people who are very likely to convert following a click) may be very discriminating in what sorts of ads they click. Therefore, the fact that a property has high quality traffic may allow the property owner to realize a high price per click, but the property may nevertheless have a low click-through rate for ads placed on that property. Some owners of online properties attempt to manipulate the price per click by exploiting the fact that traffic quality is often measured historically. Thus, property owners may create content to attract high quality traffic. Once the property has received high rating for its traffic quality, the content on the property may be modified to attract high volume, low-quality traffic in order to generate as many clicks as possible (regardless of click quality) while the historically-assessed traffic quality of the property remains high. In some cases, the property owner may resort to fraudulent click-through schemes, such as click farms, in an attempt to capitalize on the high traffic quality rating before that traffic quality rating can be updated to reflect the actual current traffic quality.

The subject matter herein provides a technique for traffic quality to be predicted in real-time, so that the traffic quality rating that is applied to an ad can reflect the true quality of the property's traffic at the time of a click. Being able to evaluate traffic quality reduces the likelihood that an advertiser will pay more for a click than the click is worth. Quick evaluation of traffic quality also tends to discourage property owners from manipulating their properties to attract high-volume, low-quality traffic to take advantage of the delays involved in doing a historical reassessment of a site's traffic quality.

In order to predict traffic quality in real time, a model is created that defines a relationship between observable features of the property and the quality of traffic visiting the site. The model may be created in any appropriate manner. One example way to create the model is through machine learning. In order to use machine learning, data is collected concerning property features and actual traffic quality. A statistical machine learning technique such as linear regression may be used to quantify the relationship between various combinations of property features and the traffic quality. When such a model is created, it is possible to predict the current traffic quality of a property by applying the model to the property's current set of features. The technique of predicting the current traffic quality from observable features of the property is in contrast to the technique of analyzing historical traffic. The former technique allows traffic quality to be assessed in the present, as compared with having to wait for a historical analysis of past traffic.

Given a way of predicting the current traffic quality of a property in real-time, the traffic quality rating may be adjusted accordingly, and the adjusted rating may be used to determine how much a click costs for an ad placed on that property. Thus, if the publisher of a web site that attracts high quality traffic abruptly changes the content to attract low quality traffic (e.g., by abruptly changing the content from luxury cars to pornography), the model can quickly predict the change in the nature of traffic on that property, and can adjust the multiplier for the click-through price of an accordingly. Moreover, the fact that a site makes abrupt changes to its traffic quality may be an indication that the publisher of the site is trying to manipulate the click-through price associated with that site. Since such behavior disrupts the smooth flow of an advertising system, the owner of the advertising engine may want to penalize such behavior. Thus, when abrupt changes, or frequent changes, to a property's quality are detected, the advertising engine may keep the traffic quality rating of a property low even after the actual quality has recovered. This type of penalty tends to discourage publishers from using changes in traffic quality to manipulate the click-through price on their site.

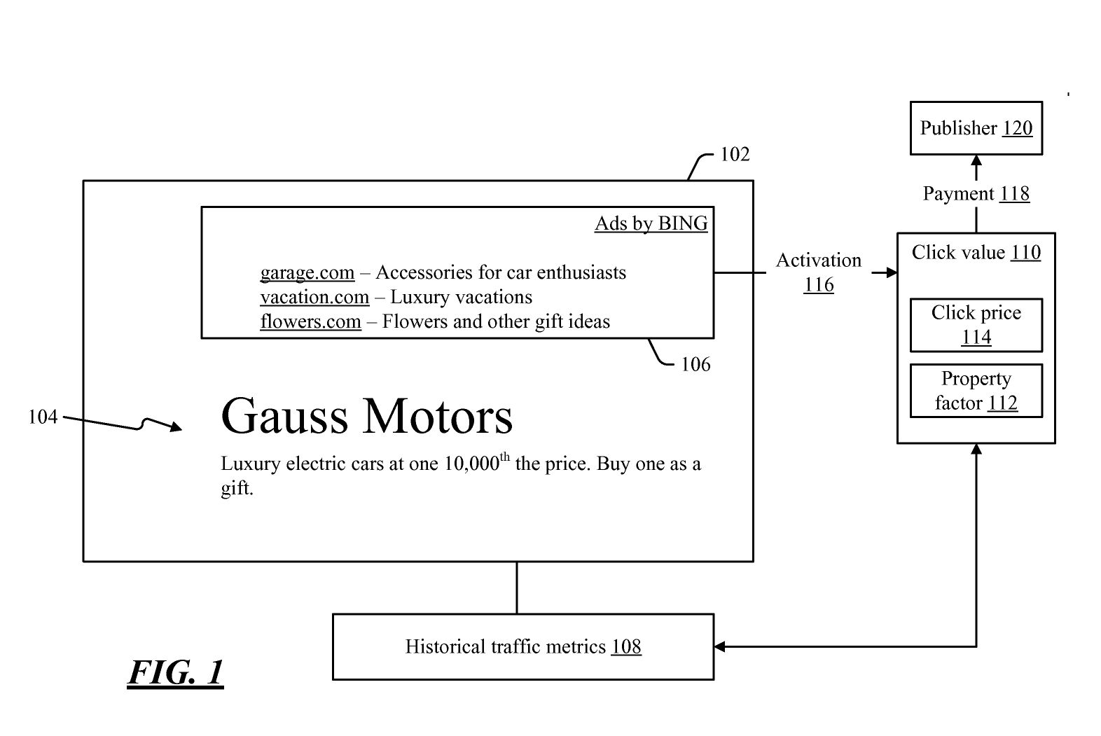

Turning now to the drawings, FIG. 1 shows an example property 102 on which ads may be placed. In the example of FIG. 1, property 102 is shown as a web site, although property 102 could be any type of online property. Another example of such a property is an application (app) that can be viewed on a smart phone or tablet, since ad impressions can be made in a viewing area of the app while a user is using such an app. Property 102, in this example, is a web site for a luxury electric car company named “Gauss Motors.” Property 102 includes content 104. A set of ads 106 may be placed on the site. Ads 106 may be placed on the site by a third-party advertising engine. In the example shown, the ads are provided by the BING online service (as indicated by the “Ads by BING” legend). Ads 106 may be chosen based on any criteria. In one example, the ads are chosen based on keywords that appear in content 104 of the site itself. For example, ads 106 include the web sites garage.com, vacation.com, and flowers.com. The owners of these sites may have bid on the keywords “cars”, “luxury”, and “gift”, respectively, so these web sites may be chosen as ads based on the fact that those keywords appear in content 104. Choosing ads based on the keywords that appear on a site is merely one way to choose ads to be placed on a property. The ads could be chosen using any appropriate technique.

Property 102 may be associated with historical traffic metrics 108, which quantify the nature of traffic that spends time on property 102. Historical traffic metrics 108 may contain various types of data. However, one piece of data that may be of particular interest to advertisers is the conversion rate for clicks that are generated on property 102. That is, for ad impressions that are shown on property 102, some percentage of those ad impressions generates click-throughs. Then, some percentage of the click-throughs generates conversions. (As explained above, conversions refer to behavior that the advertiser wants the user to engage in following a click, whether that behavior is a retail purchase, completion of a survey, or any other type of behavior.) From the perspective of an advertiser who is paying for a click, traffic quality is a measure of the percentage of click-throughs that generate conversions, and the value of those conversions. Different sites may have different conversion rates for the same ad. For example, the garage.com ad may have a 50% conversion rate on the Gauss Motors web site, but a 10% conversion rate on the Budget Motors web site. This difference may be due to the different kinds of people who visit these different web sites. (People who visit Gauss Motors might be more serious consumers with more disposable income than people who visit Budget Motors.)

Historical traffic metrics 108 may be used to calculate a click value 110. For example, historical traffic metrics 108 associated with a property may be used to calculate a property factor 112. Multiplying the property factor 112 by a benchmark click price 114 associated with a particular ad yields the actual click value. (E.g., a property factor of 1.3 and a benchmark click price of $1 for a particular ad yields a click value of $1.30 when an impression of that ad is shown on property 102.) When the user performs a click (or other activation 116) of an ad, payment 118 is made to publisher 120 of property 102, based on the click value 110. The advertiser may then be billed for the price of the click. (It may the case that publisher 120 receives less than the price that the advertiser paid for the click, since the advertising engine that places the ad may take a commission.) It is noted that, in some cases, the click (or other activation) of an ad is the same event as the conversion—e.g., in the case of an ad that invites the user to click in order to call, or to obtain a map, clicking to place the call or obtain the map may be the conversion behavior that the advertiser is seeking.

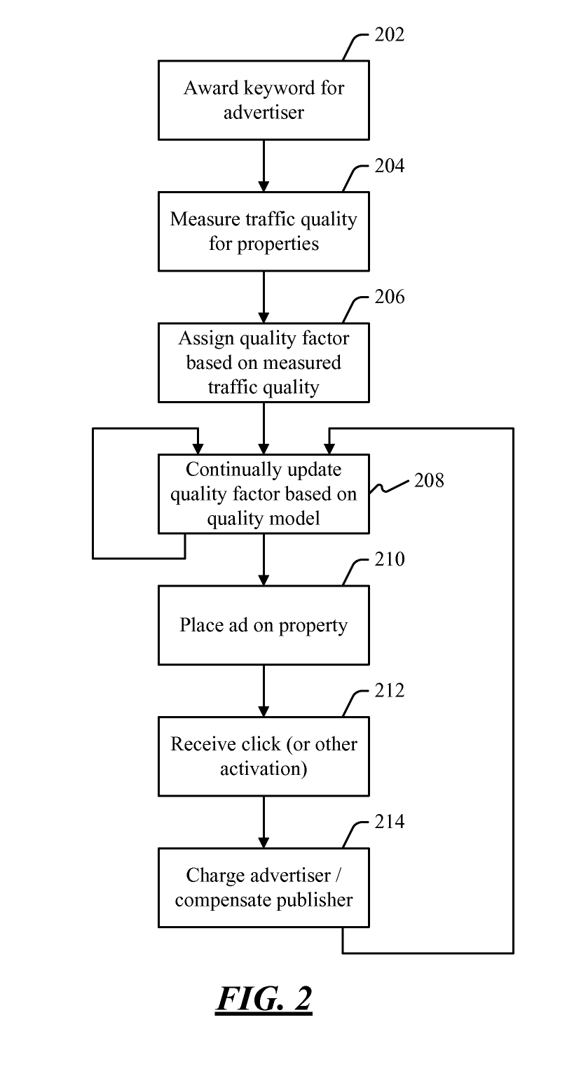

FIG. 2 shows an example process in which ads are displayed and priced.

At 202, a keyword may be awarded to an advertiser. For example, potential advertisers may bid on keywords with an advertising service in an auction. (In one example, an automated Generalized Second Price (GSP) auction is used to award keywords to bidders. However, any appropriate mechanism may be used.) The award of a keyword to a particular advertiser results in assigning a benchmark price to that keyword. The benchmark price represents the price that the advertiser would pay for a click on his or her ad when the ad is displayed in response to the presence of a keyword on a site of benchmark quality. (There may also be adjustments to the price based on ad position—e.g., placement at the top of a web page may result in a higher payment per click than placement on the side of the page.)

At 204, traffic quality for properties is measured. Traffic quality, as discussed above, includes information about the conversion rates for click-throughs occurring on a particular property, as well as the average value of conversions that occur. For example, when an ad is placed on web site A, 50% of the clicks on that ad may result in conversions, in which case the conversion rate for web site A is 50%. When an ad is placed on web site B, 10% of the clicks on that ad may result in conversions, in which case the conversion rate for web site B is 10%. This difference in conversion rate is one indication that traffic on web site A is (from an advertiser's perspective) of higher quality than the traffic on web site B. This understanding of “quality” lies in the fact that a click costs money for the advertiser whether or not it results in a conversion, so properties that tend to attract people who tend to follow through with the ads on which they click are perceived as having higher quality traffic. Traffic quality can also be measured based on the average value of a conversion—e.g., clicks that result in $10 purchases and clicks that result in $100 purchases are both examples of conversions, but the $100 purchases are more valuable to the advertiser than the $10 purchases, so the kind of people who make $100 purchases may be perceived as being higher quality traffic.

It is noted that the act of “measuring” traffic quality for a property may be performed in any appropriate manner. As discussed above, traffic quality can be measured predictively by applying a model to a property's features. However, other techniques for measuring a property's traffic quality (e.g., historical analysis of traffic) also constitute measurement of a site's quality.

At 206, a quality factor is assigned to a property based on the measured quality. At 208, the quality factor is continually or recurrently updated. For example, when a model is used to predict traffic quality, the model may be continually applied to a property over time, in order to predict traffic quality as a function of the current (changing) state of the property. In one example, the property is sampled periodically (e.g., each day, each hour, twice per day, etc.), and the quality factor is updated accordingly.

At some point in the future, an ad is placed on a property (at 210). A click (or other activation) of the ad is then received at 212. (“Clicking” is historically the term used for interacting with an ad, since users interacted with early ads by clicking on them with a mouse. As devices evolve, users often interact with an ad by tapping or otherwise gesturing on a touch screen, by voice activation, by hovering with a pointing device, etc. “Activation” is a general term for these behaviors. However it will be understood that the acts of “clicking” on an ad, or “activating” an ad, refer to any user engagement with an ad that triggers a charge to the advertiser, whether or not that engagement takes the form of a traditional “click.”)

Based on the click or activation received, the advertiser is charged, and the publisher of the property on which the ad is place is compensated (at 214). In one example, the price may be based on the product of benchmark price of the keyword that caused the selection of the ad, and on the traffic quality factor for the property on which the ad is placed. For example, if the keyword “cars” causes an ad to be selected, and if “cars” has a benchmark price of $2, and if the property on which the ad is placed has a traffic quality factor of 1.5, then the price paid for a click on the ad would be $3.00.

The process may then return to 208, where the traffic quality factor for the property may continue to be updated to reflect changing conditions on the property. These changing conditions may affect a prediction model's estimate of the traffic quality, and the traffic quality factor may be updated accordingly.

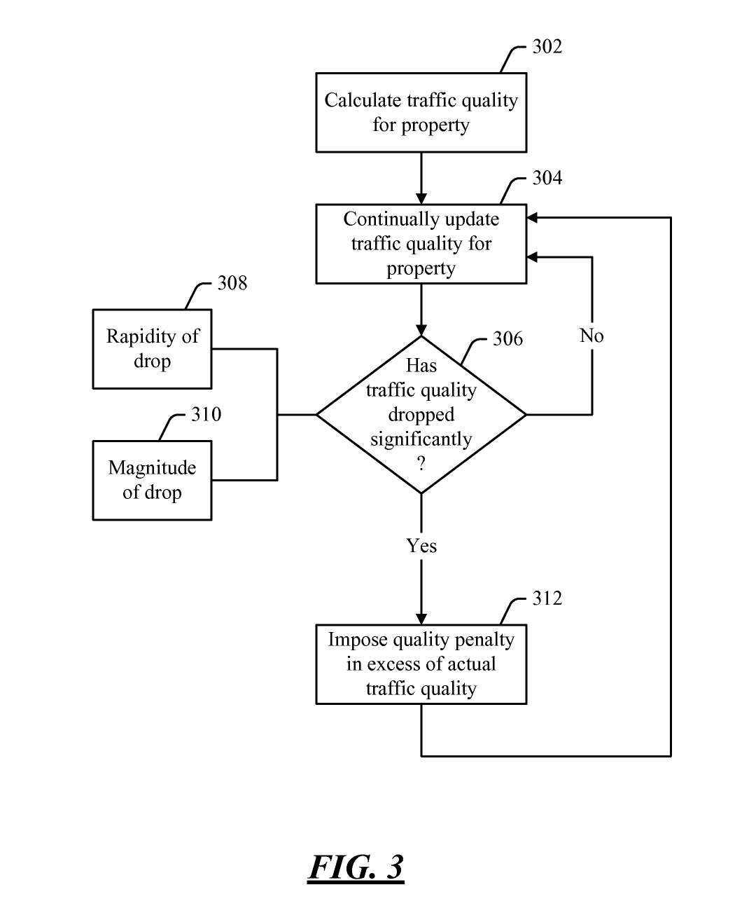

FIG. 3 shows an example process that may be used to set a traffic quality factor for a property. The example shown in FIG. 3 may be used to penalize publishers that appear to be manipulating traffic quality to artificially increase their click-through revenue. However, the process shown in FIG. 3 is only an example, and any appropriate technique may be used to set the traffic quality factor.

At 302, the traffic quality factor for a property is calculated. The traffic quality factor is then continually updated at 304. The updating of the traffic quality factor may be performed by collecting data on the property and applying a prediction model to that data, where the model predicts the current traffic quality from observable data about the property.

At 306, it is determined whether traffic quality has experienced a significant drop. The significance of a drop in traffic quality may be assessed in various ways. One way to assess the significance of the drop is based on the rapidity of the drop (block 308)—i.e., how abruptly the traffic quality falls. Another example way to assess the significance of the drop is based on the magnitude of the drop (block 310). As an alternative to the techniques listed at blocks 308 and 310, any appropriate technique for judging the level of significance of the drop may be used.

If there is no significant drop in quality, then the process returns to 304 to continue to update the traffic quality for the property. If there is a significant drop in traffic quality, then the process continues to 312, where a penalty in excess of the actual drop in traffic quality is imposed. For example, if traffic quality drops from 0.7 to 0.3, and if this drop is deemed significant, then the traffic quality assigned to the property might be 0.2. Even though the site has an actual traffic quality of 0.3, assigning the site a quality rating of 0.2 penalizes the publisher of the property for having allowed the quality to drop to as significantly as it did. The reason to penalize the publisher, as noted above, is that some publishers may try to increase their quality and then abruptly attract low-quality, high-volume, high-click-rate traffic in order to leverage any time lag that might exist between when a property's quality actually drops and when the quality can be reassessed for the purpose of click pricing. Such behavior—which is effectively an attempt to game the click pricing algorithm—can be discouraged by downgrading a property's traffic quality factor to a level below the actual traffic quality of that property.

After a penalty is imposed at 312, the process returns to 304 to continue updating the traffic quality for the property. It is noted that even if traffic quality improves, the penalty might not be lifted right away. There may be a policy that calls for traffic quality of a property to exhibit some uniformity for some pre-determined amount of time—as an indication that manipulation of the traffic quality has stopped—before the penalty can be removed. Thus, the penalty might be maintained until the property exhibits some level of traffic quality uniformity for some amount of time, even after traffic quality for the property recovers.

As noted above, traffic quality may be determined predictively using a model. The model may be tuned through machine learning, which involves collection of data. In one example, independent variables are defined, where the independent variables reflect observable traits of a property. Dependent variables are also defined, where the dependent variables reflect measures of traffic quality. Machine learning is a statistical process that attempts to discover the relationship between the independent variables and the dependent variables. The relationship, when discovered, constitutes a model that may be used to predict the dependent variables from the independent variables. If the traffic quality of the site is measured (or a function of) one or more independent variables, and if observable features of the site are reflected in the independent variables, then the model effectively predicts the traffic quality of a site from observable features of the site.

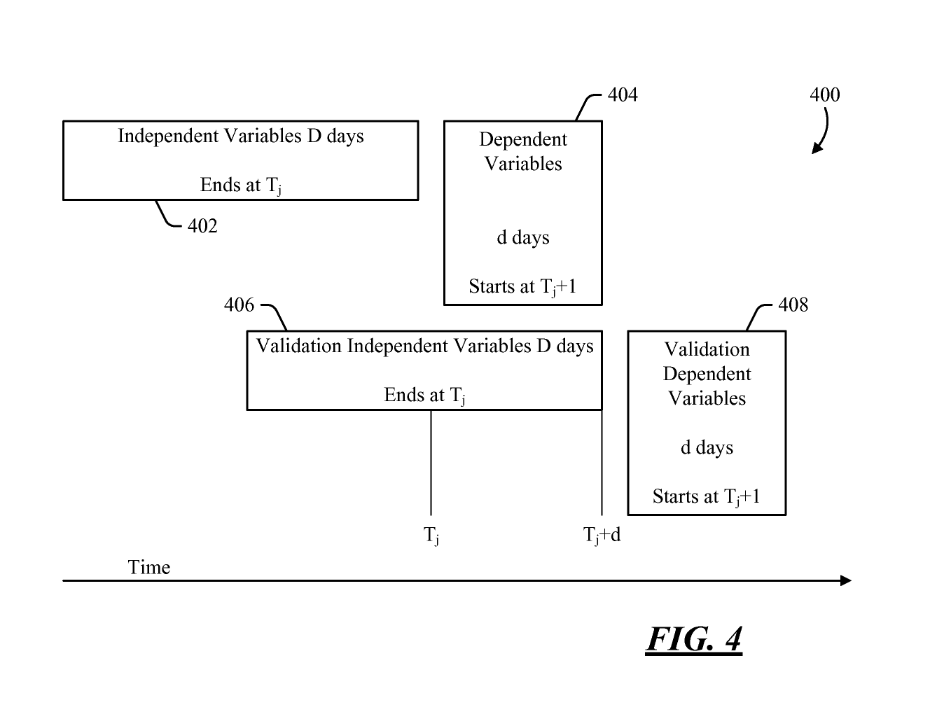

FIG. 4 shows a timeline 400 that demonstrate the process of model training and validation. Blocks 402 and 404 represent training data. Block 402 represents the act of collecting independent variables from properties over a period of D days. Block 404 represents the act of collecting dependent variables from properties over a period of d days after the independent variables are collected. The model is trained on the data collected at blocks 402 and 404. Blocks 406 and 408 represent the acts of collecting independent and dependent variables over periods of D days and d days, respectively. (In one example, D=7 and d=3, although the subject matter herein is not limited to these values.) The data collected at blocks 406 and 408 constitute validation data that is used to validate the model that is trained on the data collected at blocks 402 and 404. The collection of validation data is shifted d days ahead of the collection of training data, so that the collection of independent variables for validation (block 406) ends at the same time as collection of dependent variables for training (block 404). The offset in these collection periods allows the model to be validated against set of data different from that on which the model was trained. The trained model's precision can be calculated and quantified by determining how well the trained model is able to predict the validation dependent variables (block 408) from the validation independent variables (block 406). Moreover, since models can change over time, the fact that the training and validation data are collected relatively close in time to each other helps to ensure that the trained model is still relevant to the data against which it is being validated.

In one example, the model is a two stage model, in which two separate forms of training are used. In such an example, logistic regression may be used to predict “zero outcomes”—i.e., those clicks that do not result in conversion. Among the non-zero outcomes, random forest regression or gradient boosted tree regression may be used to predict the value of the conversions. This two stage-model helps to address the problem that data on conversions tends to be noisy, due to the fact that each advertiser may define the notion of a conversion in its own way.

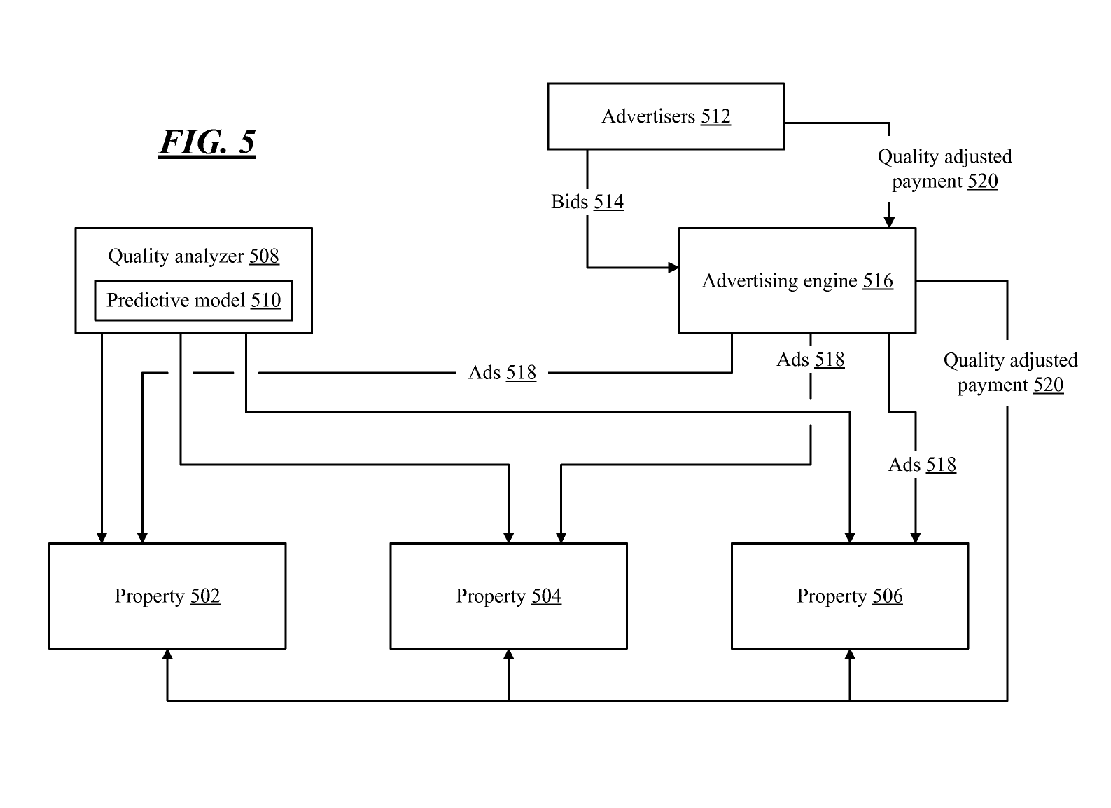

FIG. 5 shows an example system in which traffic quality may be analyzed and use for click pricing. Properties 502, 504, and 506 are online locations—e.g., web sites that can be visited with a browser, or online services that can be visited with an app. Quality analyzer 508 assesses the traffic quality of the properties. The assessment of traffic quality may be made using a predictive model 510, as described above.

Advertisers 512 submit bids 514 on keywords to an advertising engine 516. Based on these bids, advertising engine 516 places the ads 518 on properties 502-506. When a user clicks on (or otherwise activates) an ad, the advertiser whose ad is clicked is charged for the click. The amount of the charge is a quality-adjusted payment 520. The amount of the payment may be based on a benchmark price for that ad, multiplied by the traffic quality factor associated with the property on which the ad is placed. The quality adjusted payment 520 may then be transmitted to the owner of the property on which the ad had been placed when the user clicked on the ad.

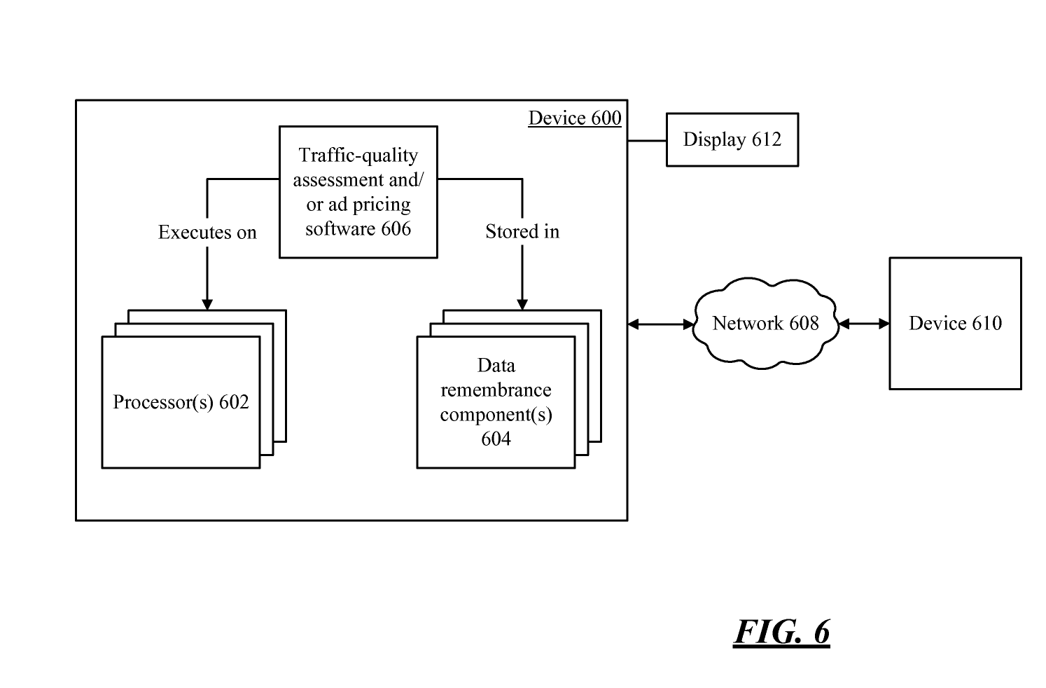

FIG. 6 shows an example environment in which aspects of the subject matter described herein may be deployed.

Device 600 includes one or more processors 602 and one or more data remembrance components 604. Device 600 may be any type of device with some computing power. A smart phone is one example of device 600, although device 600 could be a desktop computer, laptop computer, tablet computer, set top box, or any other appropriate type of device. Processor(s) 602 are typically microprocessors, such as those found in a personal desktop or laptop computer, a server, a handheld computer, or another kind of computing device. Data remembrance component(s) 604 are components that are capable of storing data for either the short or long term. Examples of data remembrance component(s) 604 include hard disks, removable disks (including optical and magnetic disks), volatile and non-volatile random-access memory (RAM), read-only memory (ROM), flash memory, magnetic tape, etc. Data remembrance component(s) are examples of computer-readable (or device-readable) storage media. Device 600 may comprise, or be associated with, display 612, which may be a cathode ray tube (CRT) monitor, a liquid crystal display (LCD) monitor, or any other type of monitor. Display 612 may be an output-only type of display; however, in another non-limiting example, display 612 may be (or comprise) a touch screen that is capable of both displaying and receiving information.

Software may be stored in the data remembrance component(s) 604, and may execute on the one or more processor(s) 602. An example of such software is traffic-quality assessment and/or ad pricing software 606, which may implement some or all of the functionality described above in connection with FIGS. 1-5, although any type of software could be used. Software 606 may be implemented, for example, through one or more components, which may be components in a distributed system, separate files, separate functions, separate objects, separate lines of code, etc. A device (e.g., smart phone, personal computer, server computer, handheld computer, tablet computer, set top box, etc.) in which a program is stored on hard disk, loaded into RAM, and executed on the device's processor(s) typifies the scenario depicted in FIG. 6, although the subject matter described herein is not limited to this example.

The subject matter described herein can be implemented as software that is stored in one or more of the data remembrance component(s) 604 and that executes on one or more of the processor(s) 602. As another example, the subject matter can be implemented as instructions that are stored on one or more device-readable media. Such instructions, when executed by a phone, a computer, or another machine, may cause the phone, computer, or other machine to perform one or more acts of a method. The instructions to perform the acts could be stored on one medium, or could be spread out across plural media, so that the instructions might appear collectively on the one or more computer-readable (or device-readable) media, regardless of whether all of the instructions happen to be on the same medium.

Computer-readable media includes, at least, two types of computer-readable media, namely computer storage media and communication media. Likewise, device-readable media includes, at least, two types of device-readable media, namely device storage media and communication media.

Computer storage media (or device storage media) includes volatile and non-volatile, removable and non-removable media implemented in any method or technology for storage of information such as computer readable instructions, data structures, program modules, or other data. Computer storage media (and device storage media) includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that may be used to store information for access by a computer or other type of device.

In contrast, communication media may embody computer readable instructions, data structures, program modules, or other data in a modulated data signal, such as a carrier wave, or other transmission mechanism. As defined herein, computer storage media does not include communication media. Likewise, device storage media does not include communication media.

Additionally, any acts described herein (whether or not shown in a diagram) may be performed by a processor (e.g., one or more of processors 602) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, device 600 may be communicatively connected to one or more other devices through network 608. Device 610, which may be similar in structure to any of the examples of device 600, is kind of device that can be connected to device 600, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A device-readable storage medium comprising executable instructions for pricing an advertisement, the executable instructions, when executed by a device, causing the device to perform acts comprising:
assessing traffic quality of an online property to determine a traffic quality factor for said online property;
continually updating said traffic quality factor for said online property by reassessing traffic quality of said property;
determining to place said advertisement on said property, there being a benchmark price for activation of said advertisement, an adjusted price of said advertisement being based on said benchmark price and on said traffic quality factor when said advertisement is activated from said property;
in response to activation of said advertisement from said property, charging an advertiser said adjusted price; and
transmitting an amount that is based on said adjusted price to a publisher of said property.

2. The device-readable storage medium of claim 1, said property being a web site, said advertisement being placed on said web site.

3. The device-readable storage medium of claim 1, said property being an application that accesses an online service, said advertisement being placed in a viewing area of said application.

4. The device-readable storage medium of claim 1, said assessing and said reassessing of said traffic quality being performed using a predictive model.

5. The device-readable storage medium of claim 1, said adjusted price being determined by performing acts comprising:
multiplying said traffic quality factor by said benchmark price.

6. The device-readable storage medium of claim 1, said acts further comprising:
determining that traffic quality on said property has experienced a drop;
determining that said drop in traffic quality is in excess of a level of significance; and
setting said traffic quality factor for said property below an amount measured by a traffic quality assessment of said property.

7. The device-readable storage medium of claim 6, said acts further comprising:
determining, after said drop in traffic quality, that traffic quality on said property has recovered; and
maintaining said traffic quality factor below an amount measured by a traffic quality assessment of said property until traffic quality on said property exhibits a level of uniformity for an amount of time.

8. A method of pricing an advertisement placed on an online property, the method comprising:
using a processor to perform acts comprising:
continually assessing traffic quality at said property to determine a traffic quality factor for said online property;
determining to place said advertisement on said property, there being a benchmark price for activation of said advertisement, an adjusted price of said advertisement being based on said benchmark price and on said traffic quality factor when said advertisement is activated from said property;
in response to activation of said advertisement from said property, charging an advertiser said adjusted price; and
transmitting an amount that is based on said adjusted price to a publisher of said property.

9. The method of claim 8, said property being a web site, said advertisement being placed on said web site.

10. The method of claim 8, said property being an application that accesses an online service, said advertisement being placed in a viewing area of said application.

11. The method of claim 8, said assessing of said traffic quality being performed using a predictive model that predicts current traffic quality from observable features of said property.

12. The method of claim 8, said adjusted price being determined by performing acts comprising:
multiplying said traffic quality factor by said benchmark price.

13. The method of claim 8, said acts further comprising:
determining that traffic quality on said property has experienced a drop;
determining that said drop in traffic quality is in excess of a level of significance; and
setting said traffic quality factor for said property below an amount measured by a traffic quality assessment of said property.

14. The method of claim 13, said acts further comprising:
determining, after said drop in traffic quality, that traffic quality on said property has recovered; and
maintaining said traffic quality factor below an amount measured by a traffic quality assessment of said property until traffic quality on said property exhibits a level of uniformity for an amount of time.

15. A system for pricing an advertisement, the system comprising:
a memory;
a processor;
a component that is stored in said memory, that executes on said processor, that assesses traffic quality of an online property to determine a quality factor for said online property, that recurrently updates said quality factor for said online property by reassessing traffic quality of said property, that determines to place said advertisement on said property, there being a reference price for activation of said advertisement that is set without regard to where an impression of said advertisement will be made, an adjusted price of said advertisement being based on said reference price and on said quality factor, said component charging an advertiser said adjusted price in response to activation of said advertisement from said property, said component transmitting an amount that is based on said adjusted price to a publisher of said property.

16. The system of claim 15, said property being a web site, said advertisement being placed on said web site.

17. The system of claim 15, said property being an application that accesses an online service, said advertisement being placed in a viewing area of said application.

18. The system of claim 15, said traffic quality being assessed and reassessed using a predictive model.

19. The system of claim 15, said component determining said adjusted price by multiplying said quality factor by said reference price.

20. The system of claim 15, said component determining that traffic quality on said property has experienced a drop, determining that said drop in traffic quality is in excess of a level of significance, and setting said quality factor for said property below an amount measured by a traffic quality assessment of said property.
